(19) United States
(12) Patent Application Publication
(10) Pub. No.: US 2015/0317091 A1
(43) Pub. Date: Nov. 5, 2015

(54) SYSTEMS AND METHODS FOR ENABLING LOCAL CACHING FOR REMOTE STORAGE DEVICES OVER A NETWORK VIA NVME CONTROLLER

(71) Applicant: CAVIUM, INC., San Jose, CA (US)

(72) Inventors: Muhammad Raghib HUSSAIN, Saratoga, CA (US); Vishal MURGAI, Cupertino, CA (US); Manojkumar PANICKER, Sunnyvale, CA (US); Faisal MASOOD, San Jose, CA (US); Brian FOLSOM, Northborough, MA (US); Richard Eugene KESSLER, Northborough, MA (US)

(21) Appl. No.: 14/317,467

(22) Filed: Jun. 27, 2014

Related U.S. Application Data
(60) Provisional application No. 61/987,597, filed on May 2, 2014.

(51) Int. Cl. G06F 3/06; G06F 12/08

(52) U.S. Cl. CPC G06F 3/0619; G06F 3/0688; G06F 3/0655; G06F 3/0665; G06F 12/0873; G06F 12/0862; G06F 2003/0692; G06F 2212/602

(57) ABSTRACT

A new approach is proposed that contemplates systems and methods to support mapping/importing remote storage devices as NVMe namespace(s) via an NVMe controller using a storage network protocol and utilizing one or more storage devices locally coupled to the NVMe controller as caches for fast access to the mapped remote storage devices. The NVMe controller exports and presents the NVMe namespace(s) of the remote storage devices to one or more VMs running on a host attached to the NVMe controller. Each of the VMs running on the host can then perform read/write operations on the logical volumes. During a write operation, data to be written to the remote storage devices by the VMs is stored in the locally coupled storage devices first before being transmitted over the network. The locally coupled storage devices may also cache data intelligently pre-fetched from the remote storage devices based on reading patterns and/or pre-configured policies of the VMs in anticipation of read operations.

### CROSS-REFERENCE TO RELATED APPLICATIONS

This application claims the benefit of U.S. Provisional Patent Application No. 61/987,956, filed May 2, 2014 and entitled “Systems and methods for accessing extensible storage devices over a network as local storage via NVMe controller,” which is incorporated herein in its entirety by reference.

This application is related to co-pending U.S. patent application Ser. No. 14/279,712, filed May 16, 2014 and entitled “Systems and methods for NVMe controller virtualization to support multiple virtual machines running on a host,” which is incorporated herein in its entirety by reference.

This application is related to co-pending U.S. patent application Ser. No. 14/300,552, filed Jun. 10, 2014 and entitled “Systems and methods for enabling access to extensible storage devices over a network as local storage via NVMe controller,” which is incorporated herein in its entirety by reference.

### BACKGROUND

Service providers have been increasingly providing their web services (e.g., web sites) at third party data centers in the cloud by running a plurality of virtual machines (VMs) on a host/server at the data center. Here, a VM is a software implementation of a physical machine (i.e. a computer) that executes programs to emulate an existing computing environment such as an operating system (OS). The VM runs on top of a hypervisor, which creates and runs one or more VMs on the host. The hypervisor presents each VM with a virtual operating platform and manages the execution of each VM on the host. By enabling multiple VMs having different operating systems to share the same host machine, the hypervisor leads to more efficient use of computing resources, both in terms of energy consumption and cost effectiveness, especially in a cloud computing environment.

Non-volatile memory express, also known as NVMe or NVM Express, is a specification that allows a solid-state drive (SSD) to make effective use of a high-speed Peripheral Component Interconnect Express (PCIe) bus attached to a computing device or host. Here the PCIe bus is a high-speed serial computer expansion bus designed to support hardware I/O virtualization and to enable maximum system bus throughput, low I/O pin count and small physical footprint for bus devices. NVMe typically operates on a non-volatile memory controller of the host, which manages the data stored on the non-volatile memory (e.g., SSD, SRAM, flash, HDD, etc.) and communicates with the host. Such an NVMe controller provides a command set and feature set for PCIe-based SSD access with the goals of increased and efficient performance and interoperability on a broad range of enterprise and client systems. The main benefits of using an NVMe controller to access PCIe-based SSDs are reduced latency, increased Input/Output (I/O) operations per second (IOPS) and lower power consumption, in comparison to Serial Attached SCSI (SAS)-based or Serial ATA (SATA)-based SSDs through the streamlining of the I/O stack.

Currently, a VM running on the host can access the PCIe-based SSDs via the physical NVMe controller attached to the host and the number of storage volumes the VM can access is constrained by the physical limitation on the maximum number of physical storage units/volumes that can be locally coupled to the physical NVMe controller. Since the VMs running on the host at the data center may belong to different web service providers and each of the VMs may have its own storage needs that may change in real time during operation and are thus unknown to the host, it is impossible to predict and allocate a fixed amount of storage volumes ahead of time for all the VMs running on the host that will meet their storage needs. Although enabling access to remote storage devices over a network can provide extensible/flexible storage volumes to the VMs during a storage operation, accessing those remote storage devices over the network could introduce latency and jitter to the operation. It is thus desirable to be able to provide storage volumes to the VMs that are both extensible and fast to access via the NVMe controller.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a system to support local caching for remote storage devices via an NVMe controller in accordance with some embodiments.

FIG. 2 depicts an example of hardware implementation of the physical NVMe controller depicted in FIG. 1 in accordance with some embodiments.

FIG. 3 depicts a non-limiting example of a lookup table that maps between the NVMe namespaces of the logical volumes and the remote storage devices/volumes in accordance with some embodiments.

FIG. 4A depicts a flowchart of an example of a process to support local caching for remote storage devices via an NVMe controller during a write operation by a VM in accordance with some embodiments.

FIG. 4B depicts a flowchart of an example of a process to support local caching for remote storage devices via an NVMe controller during a read operation by a VM in accordance with some embodiments.

FIG. 5 depicts a non-limiting example of a diagram of a system to support local caching for remote storage devices via an NVMe controller, wherein the physical NVMe controller further includes a plurality of virtual NVMe controllers in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support mapping/importing remote storage devices as NVMe namespace(s) via an NVMe controller using a storage network protocol and utilizing one or more storage devices locally coupled/directly attached to the NVMe controller as caches for fast access to the mapped remote storage devices. The NVMe controller exports and presents the NVMe namespace(s) of the remote storage devices to one or more VMs running on a host attached to the NVMe controller, wherein the remote storage devices appear as one or more logical volumes in the NVMe namespace(s) to the VMs. Each of the VMs running on the host can then perform read/write operations on the logical volumes in the NVMe namespace(s). During a write operation, data to be written to the remote storage devices by the VMs can be stored in the locally coupled storage devices first before being transmitted to the the remote storage devices over the network. The locally coupled storage devices may also intelligently pre-fetch and cache commonly/frequently used data from the remote storage devices based on reading patterns and/or pre-configured policies of the VMs. During a read operation, the cached data may be provided from the locally coupled storage devices to the VMs instead of being retrieved from the remote storage devices in real time over the network if the data requested by the read operation has been pre-fetched to the locally coupled storage devices.

By mapping and presenting the remote storage devices to the VMs as logical volumes in the NVMe namespace(s) for storage operations and utilizing the locally coupled storage devices as fast access “caches” during the operations, the proposed approach enables the VMs to not only expand the storage units available for access to remote storage devices accessible over a network, but also provide an optimized method to cache read/write operations to access these expanded storage devices fast as if they were local storage devices even though those remote storage devices are located over a network. Unlike a traditional cache often adopted by a computing device/host to reduce latency to a local storage device (e.g., hard disk drive or HDD), the proposed storage devices locally coupled to the NVMe controller reduces or eliminates latency and jitter often associated with accessing the remote storage devices over a network and thus provides the VMs and its users with much improved user experiences. As a result, the VMs are enabled to access the remote storage devices as a set of fast local storage devices via the NVMe controller during the operations, wherein the actual access to the locally coupled storage devices and/or remote storage devices by the operations are made transparent to the VMs.

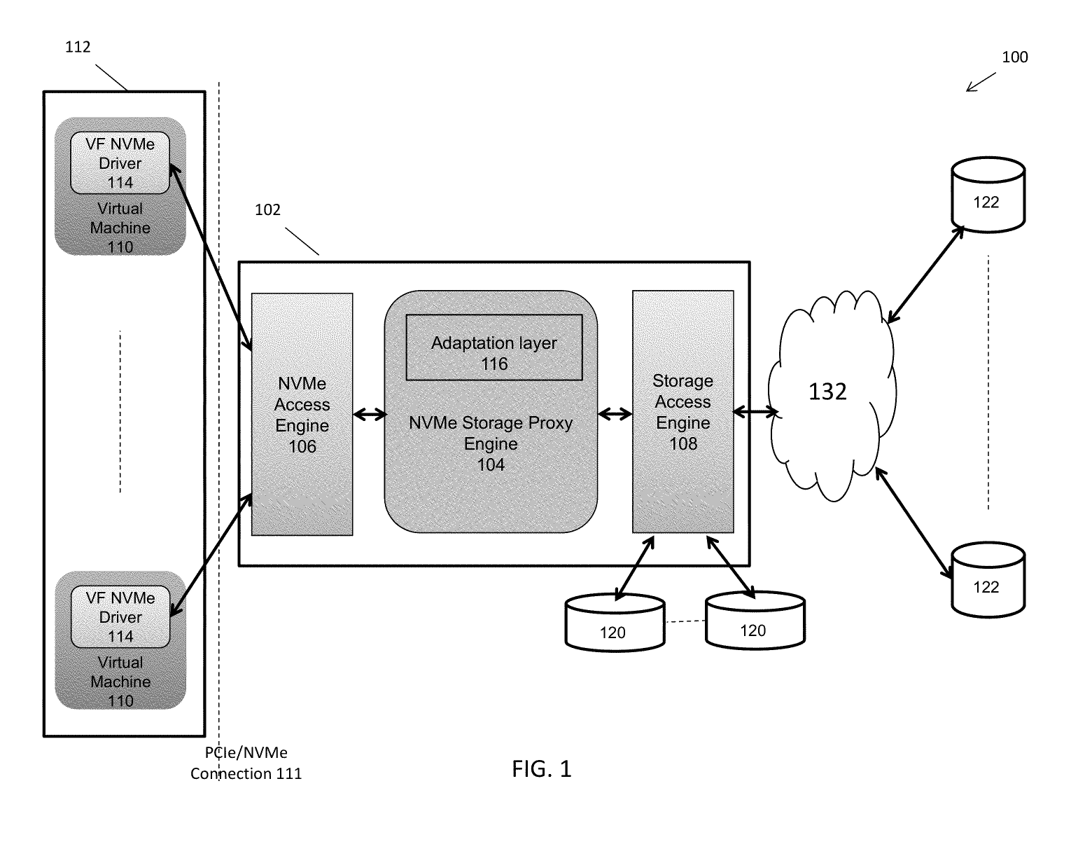

FIG. 1 depicts an example of a diagram of system 100 to support local caching for remote storage devices via an NVMe controller. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

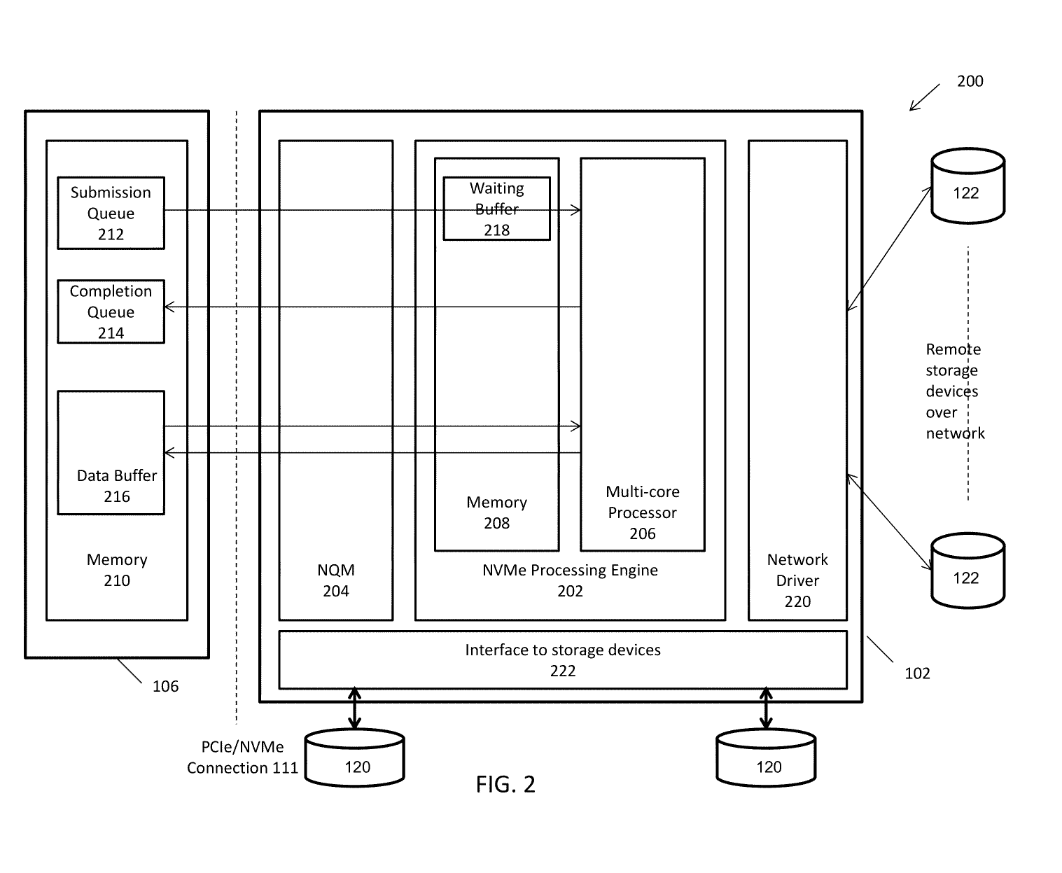

In the example of FIG. 1, the system 100 includes a physical NVMe controller 102 having at least an NVMe storage proxy engine 104, NVMe access engine 106 and a storage access engine 108 running on the NVMe controller 102. Here, the physical NVMe controller 102 is a hardware/firmware NVMe module having software, firmware, hardware, and/or other components that are used to effectuate a specific purpose. As discussed in details below, the physical NVMe controller 102 comprises one or more of a CPU or microprocessor, a storage unit or memory (also referred to as primary memory) such as RAM, with software instructions stored for practicing one or more processes. The physical NVMe controller 102 provides both Physical Functions (PFs) and Virtual Functions (VFs) to support the engines running on it, wherein the engines will typically include software instructions that are stored in the storage unit of the physical NVMe controller 102 for practicing one or more processes. As referred to herein, a PF function is a PCIe function used to configure and manage the single root I/O virtualization (SR-IOV) functionality of the controller such as enabling virtualization and exposing PCIe VFs, wherein a VF function is a lightweight PCIe function that supports SR-IOV and represents a virtualized instance of the controller 102. Each VF shares one or more physical resources on the physical NVMe controller 102, wherein such resources include but are not limited to on-controller memory 208, hardware processor 206, interface to storage devices 222, and network driver 220 of the physical NVMe controller 102 as depicted in FIG. 2 and discussed in details below.

In the example of FIG. 1, a computing unit/appliance/host 112 runs a plurality of VMs 110, each configured to provide a web-based service to clients over the Internet. Here, the host 112 can be a computing device, a communication device, a storage device, or any electronic device capable of running a software component. For non-limiting examples, a computing device can be, but is not limited to, a laptop PC, a desktop PC, a mobile device, or a server machine such as an x86/ARM server. A communication device can be, but is not limited to, a mobile phone.

In the example of FIG. 1, the host 112 is coupled to the physical NVMe controller 102 via a PCIe/NVMe link/connection 111 and the VMs 110 running on the host 112 are configured to access the physical NVMe controller 102 via the PCIe/NVMe link/connection 111. For a non-limiting example, the PCIe/NVMe link/connection 111 is a PCIe Gen3 x 8 bus.

FIG. 2 depicts an example of hardware implementation 200 of the physical NVMe controller 102 depicted in FIG. 1. As shown in the example of FIG. 2, the hardware implementation 200 includes at least an NVMe processing engine 202, and an NVMe Queue Manager (NQM) 204 implemented to support the NVMe processing engine 202. Here, the NVMe processing engine 202 includes one or more CPUs/processors 206 (e.g., a multi-core/multi-threaded ARM/MIPS processor), and a primary memory 208 such as DRAM. The NVMe processing engine 202 is configured to execute all NVMe instructions/commands and to provide results upon completion of the instructions. The hardware-implemented NQM 204 provides a front-end interface to the engines that execute on the NVMe processing engine 202. In some embodiments, the NQM 204 manages at least a submission queue 212 that includes a plurality of administration and control instructions to be processed by the NVMe processing engine 202 and a completion queue 214 that includes status of the plurality of administration and control instructions that have been processed by the NVMe processing engine 202. In some embodiments, the NQM 204 further manages one or more data buffers 216 that include data read from or to be written to a storage device via the NVMe controllers 102. In some embodiments, one or more of the submission queue 212, completion queue 214, and data buffers 216 are maintained within memory 210 of the host 112. In some embodiments, the hardware implementation 200 of the physical NVMe controller 102 further includes an interface to storage devices 222, which enables a plurality of storage devices 120 to be coupled to and accessed by the physical NVMe controller 102 locally, and a network driver 220, which enables a plurality of storage devices 122 to be connected to the NVMe controller 102 remotely of a network.

In the example of FIG. 1, the NVMe access engine 106 of the NVMe controller 102 is configured to receive and manage instructions and data for read/write operations from the VMs 110 running on the host 102. When one of the VMs 110 running on the host 112 performs a read or write operation, it places a corresponding instruction in a submission queue 212, wherein the instruction is in NVMe format. During its operation, the NVMe access engine 106 utilizes the NQM 204 to fetch the administration and/or control commands from the submission queue 212 on the host 112 based on a “doorbell” of read or write operation, wherein the doorbell is generated by the VM 110 and received from the host 112. The NVMe access engine 106 also utilizes the NQM 204 to fetch the data to be written by the write operation from one of the data buffers 216 on the host 112. The NVMe access engine 106 then places the fetched commands in a waiting buffer 218 in the memory 208 of the NVMe processing engine 202 waiting for the NVMe Storage Proxy Engine 104 to process. Once the instructions are processed, the NVMe access engine 106 puts the status of the instructions back in the completion queue 214 and notifies the corresponding VM 110 accordingly. The NVMe access engine 106 also puts the data read by the read operation to the data buffer 216 and makes it available to the VM 110.

In some embodiments, each of the VMs 110 running on the host 112 has an NVMe driver 114 configured to interact with the NVMe access engine 106 of the NVMe controller 102 via the PCIe/NVMe link/connection 111. In some embodiments, each of the NVMe driver 114 is a virtual function (VF) driver configured to interact with the PCIe/NVMe link/connection 111 of the host 112 and to set up a communication path between its corresponding VM 110 and the NVMe access engine 106 and to receive and transmit data associated with the corresponding VM 110. In some embodiments, the VF NVMe driver 114 of the VM 110 and the NVMe access engine 106 communicate with each other through a SR-IOV PCIe connection as discussed above.

In some embodiments, the VMs 110 run independently on the host 112 and are isolated from each other so that one VM 110 cannot access the data and/or communication of any other VMs 110 running on the same host. When transmitting commands and/or data to and/or from a VM 110, the corresponding VF NVMe driver 114 directly puts and/or retrieves the commands and/or data from its queues and/or the data buffer, which is sent out or received from the NVMe access engine 106 without the data being accessed by the host 112 or any other VMs 110 running on the same host 112.

In the example of FIG. 1, the storage access engine 108 of the NVMe controller 102 is configured to access and communicate with a plurality of non-volatile disk storage devices/units, wherein each of the storage units is either locally coupled to the NVMe controller 102 via the interface to storage devices 222 (e.g., local storage devices 120), or remotely accessible by the physical NVMe controller 102 over a network 132 (e.g., remote storage devices 122) via the network communication interface/driver 220 following certain communication protocols such as TCP/IP protocol. As referred to herein, each of the locally attached and remotely accessible storage devices 120 and 122 can be a non-volatile (non-transient) storage device, which can be but is not limited to, a solid-state drive (SSD), a static random-access memory (SRAM), a magnetic hard disk drive (HDD), and a flash drive. The network 132 can be but is not limited to, internet, intranet, wide area network (WAN), local area network (LAN), wireless network, Bluetooth, WiFi, mobile communication network, or any other network type. The physical connections of the network and the communication protocols are well known to those of skill in the art.

In the example of FIG. 1, the NVMe storage proxy engine 104 of the NVMe controller 102 is configured to collect volumes of the remote storage devices accessible via the storage access engine 108 over the network under the storage network protocol and convert the storage volumes of the remote storage devices to one or more NVMe namespaces each including a plurality of logical volumes (a collection of logical blocks) to be accessed by VMs 110 running on the host 112. As such, the NVMe namespaces may cover both the storage devices locally attached to the NVMe controller 102 and those remotely accessible by the storage access engine 108 under the storage network protocol. The storage network protocol is used to access a remote storage device accessible over the network, wherein such storage network protocol can be but is not limited to Internet Small Computer System Interface (iSCSI). iSCSI is an Internet Protocol (IP)-based storage networking standard for linking data storage devices by carrying SCSI commands over the networks. By enabling access to remote storage devices over the network, iSCSI increases the capabilities and performance of storage data transmission over local area networks (LANs), wide area networks (WANs), and the Internet.

In some embodiments, the NVMe storage proxy engine 104 organizes the remote storage devices as one or more logical or virtual volumes/blocks in the NVMe namespaces to which the VMs 110 can access and perform I/O operations. Here, each volume is classified as logical or virtual since it maps to one or more physical storage devices 122 remotely accessible by the NVMe controller 102 via the storage access engine 108. In some embodiments, multiple VMs 110 running on the host 112 are enabled to access the same logical volume or virtual volume and each logical/virtual volume can be shared among multiple VMs.

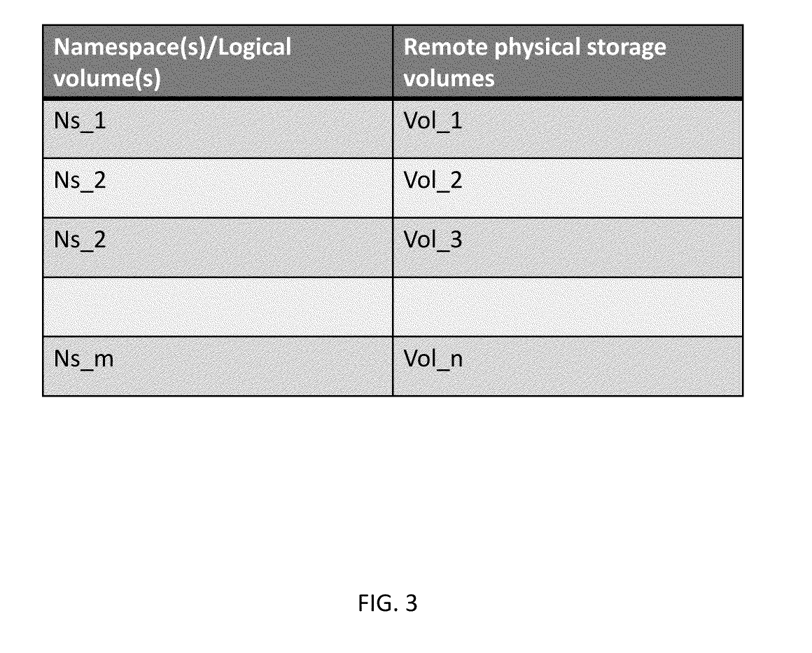

In some embodiments, the NVMe storage proxy engine 104 establishes a lookup table that maps between the NVMe namespaces of the logical volumes, Ns_1, . . . , Ns_m, and the remote physical storage devices/volumes, Vol_1, . . . , Vol_n, accessible over the network as shown by the non-limiting example depicted in FIG. 3. Here, there is a multiple-to-multiple correspondence between the NVMe namespaces and the physical storage volumes, meaning that one namespace (e.g., Ns_2) may correspond to a logical volume that maps to a plurality of remote physical storage volumes (e.g., Vol_2 and Vol_3), and a single remote physical storage volume may also be included in a plurality of logical volumes and accessible by the VMs 110 via their corresponding NVMe namespaces. In some embodiments, the NVMe storage proxy engine 104 is configured to expand the mappings between the NVMe namespaces of the logical volumes and the remote physical storage devices/volumes to add additional storage volumes on demand. For a non-limiting example, when at least one of the VMs 110 running on the host 112 requests for more storage volumes, the NVMe storage proxy engine 104 may expand the namespace/logical volume accessed by the VM to include additional remote physical storage devices.

In some embodiments, the NVMe storage proxy engine 104 further includes an adaptation layer/shim 116, which is a software component configured to manage message flows between the NVMe namespaces and the remote physical storage volumes. Specifically, when instructions for storage operations (e.g., read/write operations) on one or more logical volumes/namespaces are received from the VMs 110 via the NVMe access engine 106, the adaptation layer/shim 116 converts the instructions under NVMe specification to one or more corresponding instructions on the remote physical storage volumes under the storage network protocol such as iSCSI according to the lookup table. Conversely, when results and/or feedbacks on the storage operations performed on the remote physical storage volumes are received via the storage access engine 108, the adaptation layer/shim 116 also converts the results to feedbacks about the operations on the one or more logical volumes/namespaces and provides such converted results to the VMs 110.

In the example of FIG. 1, the NVMe access engine 106 of the NVMe controller 102 is configured to export and present the NVMe namespaces and logical volumes of the remote physical storage devices 122 to the VMs 110 running on the host 112 as accessible storage devices. The actual mapping, expansion, and operations on the remote storage devices 122 over the network using iSCSI-like storage network protocol performed by the NVMe controller 102 are transparent to the VMs 110, enabling the VMs 110 to provide the instructions through the NVMe access engine 106 to perform one or more storage operations on the logical volumes that map to the remote storage devices 122.

In the example of FIG. 1, the NVMe storage proxy engine 104 is configured to utilize the storage devices 120 locally coupled to the physical NVMe controller 102 to process the one or more storage operations on the remote storage devices 122 requested by the VMs 110. Here, the storage operations include but are not limited to, read or write operations on the remote storage devices. During a write operation on the remote storage devices 122 requested by one of the VMs 110, the NVMe storage proxy engine 104 receives the data to be written to the remote storage devices 122 from the VM 110 through the the NVMe access engine 106 and store/cache the data locally in the storage devices 120 first. Once the data is saved in the locally coupled storage devices 120, the NVMe storage proxy engine 104 provides an acknowledgement (e.g., in the form of “Write_OK”) to the corresponding VM 110 in real time that the write operation it requested has been successfully completed even if the data has yet to be saved to the remote storage devices 122.

In some embodiments, the NVMe storage proxy engine 104 maintains the data in the locally coupled storage devices 120 for a certain period of time before converting and transmitting instructions and data for the write operation from the locally coupled storage devices 120 over the network to the corresponding volumes of the remote storage devices 122 according to the storage network protocol as discussed above. In some embodiments, the NVMe storage proxy engine 104 transmits the data from the locally coupled storage devices 120 and saves the data to the remote storage devices 122 periodically according to a pre-determined schedule. In some embodiments, the NVMe storage proxy engine 104 transmits the data from the locally coupled storage devices 120 and saves the data to the remote storage devices 122 on demand or as needed (e.g., when the locally coupled storage devices 120 is almost full). Once the data has been transmitted, the NVMe storage proxy engine 104 removes it from the locally coupled storage devices 120 to leave space to accommodate future storage operations. Such “local caching first and remote saving later” approach to handle the write operation provides the VM 110 and their clients with acknowledgement in real time that the write operation it requested has been done while offering the NVMe storage proxy engine 104 with extra flexibility to handle the actual transmission and storage of the data to the remote storage devices 122 when the computing and/or network resources for such transmission are most available.

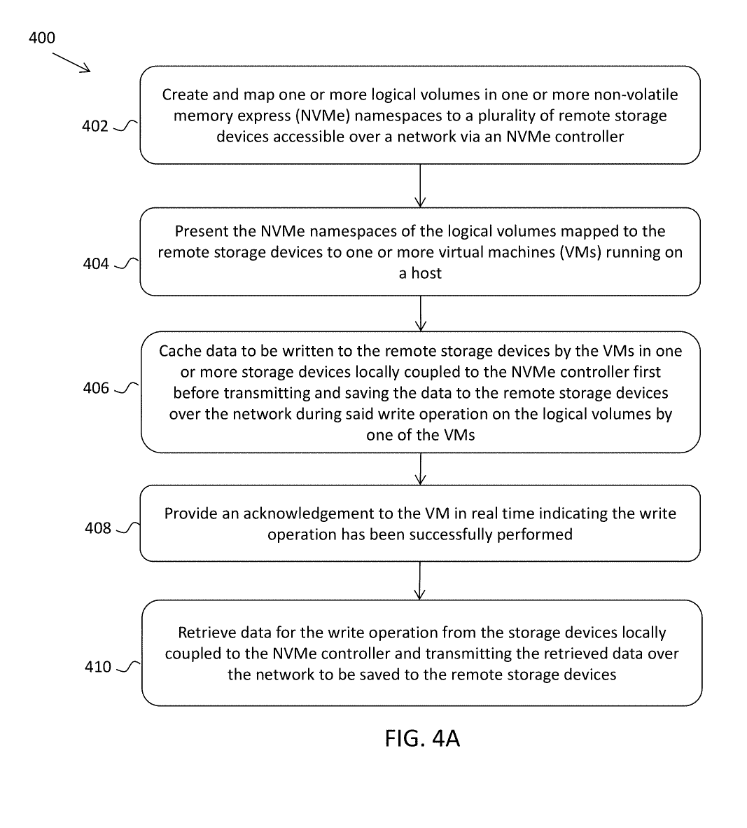

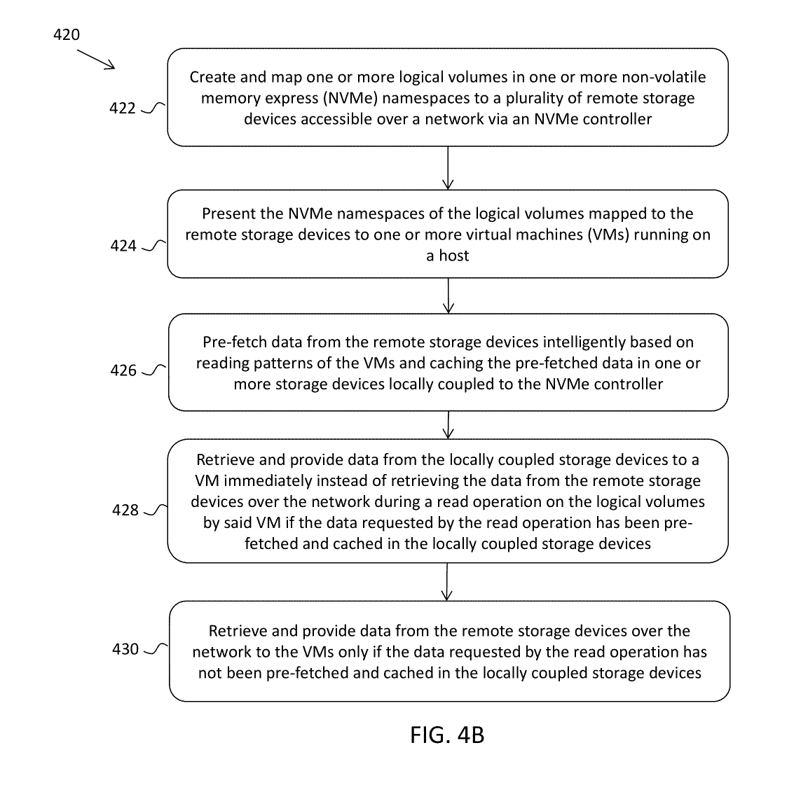

FIG. 4A depicts a flowchart of an example of a process to support local caching for remote storage devices via an NVMe controller during a write operation by a VM. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 4A, the flowchart 400 starts at block 402, where one or more logical volumes in one or more NVMe namespaces are created and mapped to a plurality of remote storage devices accessible over a network via an NVMe controller. The flowchart 400 continues to block 404, where the NVMe namespaces of the logical volumes mapped to the remote storage devices are presented to one or more virtual machines (VMs) running on a host. The flowchart 400 continues to block 406, wherein during a write operation on the logical volumes by one of the VMs, data to be written to the remote storage devices by the VM is stored in one or more storage devices locally coupled to the NVMe controller first before being transmitted and saved to the remote storage devices over the network. The flowchart 400 continues to block 408, where an acknowledgement is provided to the VM in real time indicating the write operation has been successfully performed. The flowchart 400 ends at block 410, where data for the write operation is retrieved from the storage devices locally coupled to the NVMe controller and transmitted over the network to be saved to the remote storage devices.

In some embodiments, the NVMe storage proxy engine 104 is configured to pre-fetch data from the remote storage devices 122 and cache/save it in the locally coupled storage devices 120 in anticipation of read operations on the remote storage devices 122 by the VMs 110. In some embodiments, the NVMe storage proxy engine 104 keeps track of read patterns of the VMs 110 during previous read operations and analyzes the read patterns to predict which logical volumes/blocks are most frequently requested by the VMs 110 and are most likely to be requested next by the VMs 110. For a non-limiting example, volumes/blocks preceding and/or subsequent to the ones most recently requested are likely to be requested next by the VMs 110. Once the logical volumes/blocks most likely to be requested next are determined, the NVMe storage proxy engine 104 pre-fetches such data from the remote storage devices 122 over the network via an instruction in accordance with the storage network protocol discussed above and saves the pre-fetched in the locally coupled storage devices 120 ready for access by the VMs 110. In some embodiments, the NVMe storage proxy engine 104 is configured to pre-fetch and cache data from the remote storage devices 122 based on pre-configured policies of the VMs 110, wherein the policies provide information on data blocks likely to be requested next by the VMs 110.

During a read operation on the remote storage devices 122 requested by one of the VMs 110, the NVMe storage proxy engine 104 is configured to check the locally coupled storage devices 120 first to determine if the logical volumes/blocks requested have been pre-fetched/cached in the locally coupled storage devices 120 already. If so, the NVMe storage proxy engine 104 provides the data immediately to the VM 110 in response to the read operation without having to retrieve the data from the remote storage devices 122 over the network in real time, which may be subject to network latency and jitter. The NVMe storage proxy engine 104 needs to convert the instruction for the read operation to the storage network protocol and to retrieve the data requested from the remote storage devices 122 over the network only if the data requested is not present in the locally coupled storage devices 120 already. Such a pre-fetching/caching scheme improves the response time to the read operation by the VM 100 especially when the VM 110 is requesting for data in consecutive logical volumes/blocks, which are most likely be identified based on the read patterns of the VM 110 and are thus pre-fetched to the locally coupled storage devices 120 from the remote storage devices 122.

FIG. 4B depicts a flowchart of an example of a process to support local caching for remote storage devices via an NVMe controller during a read operation by a VM. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 4B, the flowchart 420 starts at block 422, where one or more logical volumes in one or more NVMe namespaces are created and mapped to a plurality of remote storage devices accessible over a network via an NVMe controller. The flowchart 420 continues to block 424, where the NVMe namespaces of the logical volumes mapped to the remote storage devices are presented to one or more virtual machines (VMs) running on a host. The flowchart 420 continues to block 426, where data is intelligently pre-fetched from the remote storage devices based on reading patterns of the VMs and cached in one or more storage devices locally coupled to the NVMe controller. The flowchart 420 continues to block 428, where during a read operation on the logical volumes by one of the VMs, data is retrieved and provided from the locally coupled storage devices to the VMs immediately instead of being retrieved from the remote storage devices over the network if the data requested by the read operation has been pre-fetched and cached in the locally coupled storage devices. The flowchart 420 ends at block 430, where data is retrieved and provided from the remote storage devices over the network to the VMs only if the data requested by the read operation has not been pre-fetched and cached in the locally coupled storage devices.

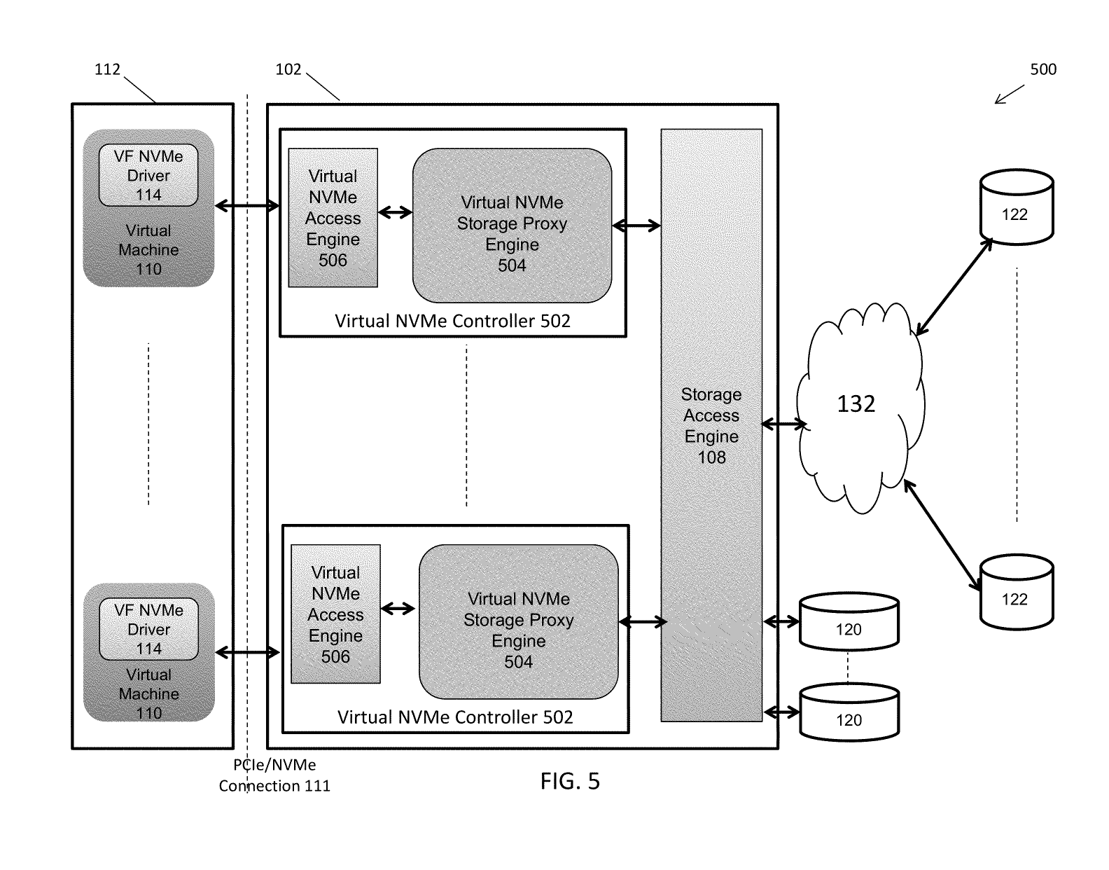

FIG. 5 depicts a non-limiting example of a diagram of system 500 to support local caching for remote storage devices via the NVMe controller 102, wherein the physical NVMe controller 102 further includes a plurality of virtual NVMe controllers 502. In the example of FIG. 5, the plurality of virtual NVMe controllers 502 run on the single physical NVMe controller 102 where each of the virtual NVMe controllers 502 is a hardware accelerated software engine emulating the functionalities of an NVMe controller to be accessed by one of the VMs 110 running on the host 112. In some embodiments, the virtual NVMe controllers 502 have a one-to-one correspondence with the VMs 110, wherein each virtual NVMe controller 104 interacts with and allows access from only one of the VMs 110. Each virtual NVMe controller 104 is assigned to and dedicated to support one and only one of the VMs 110 to access its storage devices, wherein any single virtual NVMe controller 104 is not shared across multiple VMs 110.

In some embodiments, each virtual NVMe controller 502 is configured to support identity-based authentication and access from its corresponding VM 110 for its operations, wherein each identity permits a different set of API calls for different types of commands/instructions used to create, initialize and manage the virtual NVMe controller 502, and/or provide access to the logic volume for the VM 110. In some embodiments, the types of commands made available by the virtual NVMe controller 502 vary based on the type of user requesting access through the VM 110 and some API calls do not require any user login. For a non-limiting example, different types of commands can be utilized to initialize and manage virtual NVMe controller 502 running on the physical NVMe controller 102.

In some embodiments, each virtual NVMe controller 502 depicted in FIG. 5 has one or more pairs of submission queue 212 and completion queue 214 associated with it, wherein each queue can accommodate a plurality of entries of instructions from one of the VMs 110. As discussed above, the instructions in the submission queue 212 are first fetched by the NQM 204 from the memory 210 of the host 112 to the waiting buffer 218 of the NVMe processing engine 202 as discussed above. During its operation, each virtual NVMe controller 502 retrieves the instructions from its corresponding VM 110 from the waiting buffer 218 and converts the instructions according to the storage network protocol in order to perform a read/write operation on the data stored on the local storage devices 120/remote storage devices 122 over the network by invoking VF functions provided by the physical NVMe controller 102.

As shown in the example of FIG. 5, each virtual NVMe controller 502 may further include a virtual NVMe storage proxy engine 504 and a virtual NVMe access engine 506, which functions in a similar fashion as the respective NVMe storage proxy engine 104 and an NVMe access engine 106 discussed above. In some embodiments, the virtual NVMe storage proxy engine 504 in each virtual NVMe controller 502 is configured to access the locally coupled storage devices 120 and remotely storage devices 122 via the storage access engine 108, which can be shared by all the virtual NVMe controllers 502 running on the physical NVMe controller 102. During a write operation by a VM 110, the corresponding virtual NVMe storage proxy engine 504 stores data to be written to the remote storage devices by the VM in locally coupled storage devices 120 first and provides the VM 110 with an acknowledgement indicating the write operation has been successfully performed before actually transmitting and saving the data to the remote storage devices 122 over the network. Each virtual NVMe storage proxy engine 504 may also intelligently pre-fetch and cache data from the remote storage devices and save it in the locally coupled storage devices 120 based on reading patterns of its corresponding VM 110. During a read operation by the VM 110, the corresponding virtual NVMe storage proxy engine 504 provides the data from the locally coupled storage devices 120 to the VM 110 immediately instead of retrieving the data from the remote storage devices 122 over the network if the data requested by the read operation has been pre-fetched or cached in the locally coupled storage devices 122. The virtual NVMe storage proxy engine 504 retrieves the data from the remote storage devices 122 over the network only if the data requested by the read operation has not been pre-fetched or cached in the locally coupled storage devices.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system to support local caching for remote storage devices via a NVMe controller during a write operation, comprising:
a non-volatile memory express (NVMe) storage proxy engine running on a physical NVMe controller, which in operation, is configured to:
create and map one or more logical volumes in one or more NVMe namespaces to a plurality of remote storage devices accessible over a network via a NVMe controller;
cache data to be written to the remote storage devices by a virtual machine (VM) running on a host to one or more storage devices locally coupled to the NVMe controller first before transmitting and saving the data to the remote storage devices over the network during said write operation on the logical volumes by the VM;
retrieve data for the write operation from the storage devices locally coupled to the NVMe controller and transmit the retrieved data over the network to be saved to the remote storage devices;
a NVMe access engine running on the physical NVMe controller, which in operation, is configured to:
present the NVMe namespaces of the logical volumes mapped to the remote storage devices to the VM running on the host;
provide an acknowledgement to the VM in real time indicating the write operation has been successfully performed before transmitting and saving the data to the remote storage devices over the network.

2. The system of claim 1, wherein:
the host of the VMs is an x86/ARM server.

3. The system of claim 1, wherein:
the storage devices locally coupled to the NVMe controller include one or more of a solid-state drive (SSD), a Static random-access memory (SRAM), a magnetic hard disk drive, and a flash drive.

4. The system of claim 1, wherein:
the NVMe storage proxy engine is configured to maintain the data in the locally coupled storage devices for a certain period of time before transmitting the data from the locally coupled storage devices over the network to the remote storage devices.

5. The system of claim 4, wherein:
the NVMe storage proxy engine is configured to transmit the data from the locally coupled storage devices and save the data to the remote storage devices periodically according to a pre-determined schedule.

6. The system of claim 4, wherein:
the NVMe storage proxy engine is configured to transmit the data from the locally coupled storage devices and save the data to the remote storage devices on demand or as needed.

7. The system of claim 1, wherein:
the NVMe storage proxy engine is configured to transmit and save the data to the remote storage devices over the network via an instruction in accordance with a storage network protocol.

8. The system of claim 1, wherein:
the NVMe storage proxy engine is configured to remove the data from the locally coupled storage devices to leave space to accommodate future storage operations once the data has been transmitted.

9. The system of claim 1, wherein:
the NVMe storage proxy engine is configured to establish a lookup table that maps between the NVMe namespaces of the logical volumes and the remote physical storage devices.

10. The system of claim 1, wherein:
the NVMe storage proxy engine is configured to expand mappings between the NVMe namespaces of the logical volumes and the remote physical storage devices/volumes to add additional storage volumes on demand.

11. A system to support local caching for remote storage devices via a NVMe controller during a read operation, comprising:
a non-volatile memory express (NVMe) storage proxy engine running on a physical NVMe controller, which in operation, is configured to:
create and map one or more logical volumes in one or more NVMe namespaces to a plurality of remote storage devices accessible over a network via a NVMe controller;
pre-fetch data from the remote storage devices intelligently based on reading patterns and/or pre-configured policies of one or more virtual machines (VMs) running on a host and cache the pre-fetched data in one or more storage devices locally coupled to the NVMe controller;
retrieve and provide data from the locally coupled storage devices to a VM immediately instead of retrieving the data from the remote storage devices over the network during a read operation on the logical volumes by said VM if the data requested by the read operation has been pre-fetched and cached in the locally coupled storage devices;
retrieve and provide data from the remote storage devices over the network to the VM only if the data requested by the read operation has not been pre-fetched and cached in the locally coupled storage devices;
a non-volatile memory express (NVMe) access engine running on the physical NVMe controller, which in operation, is configured to present the NVMe namespaces of the logical volumes mapped to the remote storage devices to the VMs running on the host.

12. The system of claim 11, wherein:
the NVMe storage proxy engine is configured to keep track of the read patterns of the VMs during previous read operations and analyze the read patterns to predict which logical volumes/blocks are most likely to be requested next by the VMs.

13. The system of claim 11, wherein:
the NVMe storage proxy engine is configured to pre-fetch the data from the remote storage devices over the network via an instruction in accordance with a storage network protocol.

14. A system to support local caching for remote storage devices via a NVMe controller during a write operation, comprising:
a plurality of non-volatile memory express (NVMe) virtual controllers running on a physical NVMe controller, wherein each of the NVMe virtual controllers is configured to:
create one or more logical volumes in one or more non-volatile memory express (NVMe) namespaces mapped to a plurality of remote storage devices accessible over a network;
present the NVMe namespaces of the logical volumes mapped to the remote storage devices to a corresponding virtual machine (VM) running on a host;
cache data to be written to the remote storage devices by the VM in one or more storage devices locally coupled to the NVMe controller first before transmitting and saving the data to the remote storage devices over the network during said write operation on the logical volumes by the VM;
provide an acknowledgement to the VM in real time indicating the write operation has been successfully performed;
retrieve data for the write operation from the storage devices locally coupled to the NVMe controller and transmit the retrieved data over the network to be saved to the remote storage devices.

15. A system to support local caching for remote storage devices via a NVMe controller during a read operation, comprising:
a plurality of non-volatile memory express (NVMe) virtual controllers running on a physical NVMe controller, wherein each of the NVMe virtual controllers is configured to:
create one or more logical volumes in one or more non-volatile memory express (NVMe) namespaces mapped to a plurality of remote storage devices accessible over a network;
present the NVMe namespaces of the logical volumes mapped to the remote storage devices to a corresponding virtual machine (VM) running on a host;
pre-fetch data from the remote storage devices intelligently based on reading patterns and/or pre-configured policies of the VM and cache the pre-fetched data in one or more storage devices locally coupled to the NVMe controller;
retrieve and provide data from the locally coupled storage devices to the VM immediately instead of retrieving the data from the remote storage devices over the network during a read operation on the logical volumes by the VM if the data requested by the read operation has been pre-fetched and cached in the locally coupled storage devices;
retrieve and provide data from the remote storage devices over the network to the VM only if the data requested by the read operation has not been pre-fetched and cached in the locally coupled storage devices.

16. The system of claim 14, wherein:
each of the virtual NVMe controllers is configured to interact with and allow access from one and only one VM.

17. The system of claim 14, wherein:
each of the virtual NVMe controllers is configured to support identity-based authentication and access from its corresponding VM for its operations, wherein each identity permits a different set of API calls for different types of commands used to create, initialize and manage the virtual NVMe controller and/or provide access to the logical volumes for the VM.

18. A computer-implemented method to support local caching for remote storage devices via an NVMe controller during a write operation, comprising:
creating and mapping one or more logical volumes in one or more non-volatile memory express (NVMe) namespaces to a plurality of remote storage devices accessible over a network via an NVMe controller;
presenting the NVMe namespaces of the logical volumes mapped to the remote storage devices to one or more virtual machines (VMs) running on a host;
storing data to be written to the remote storage devices by the VMs in one or more storage devices locally coupled to the NVMe controller first before transmitting and saving the data to the remote storage devices over the network during said write operation on the logical volumes by one of the VMs;
providing an acknowledgement to the VM in real time indicating the write operation has been successfully performed;
retrieving data for the write operation from the storage devices locally coupled to the NVMe controller and transmitting the retrieved data over the network to be saved to the remote storage devices.

19. The method of claim 18, further comprising:
maintaining the data in the locally coupled storage devices for a certain period of time before transmitting the data from the locally coupled storage devices over the network to the remote storage devices.

20. The method of claim 19, further comprising:
transmitting the data from the locally coupled storage devices and saving the data to the remote storage devices periodically according to a pre-determined schedule.

21. The method of claim 19, further comprising:
transmitting the data from the locally coupled storage devices and save the data to the remote storage devices on demand or as needed.

22. The method of claim 18, further comprising:
transmitting and saving the data to the remote storage devices over the network via an instruction in accordance with a storage network protocol.

23. The method of claim 18, further comprising:
removing the data from the locally coupled storage devices to leave space to accommodate future storage operations once the data has been transmitted.

24. The method of claim 18, further comprising:
establishing a lookup table that maps between the NVMe namespaces of the logical volumes and the remote physical storage volumes.

25. The method of claim 18, further comprising:
expanding mappings between the NVMe namespaces of the logical volumes and the remote physical storage devices/volumes to add additional storage volumes on demand.

26. A computer-implemented method to support local caching for remote storage devices via a NVMe controller during a read operation, comprising:
creating and mapping one or more logical volumes in one or more non-volatile memory express (NVMe) namespaces to a plurality of remote storage devices accessible over a network via a NVMe controller;
presenting the NVMe namespaces of the logical volumes mapped to the remote storage devices to one or more virtual machines (VMs) running on a host;
pre-fetching data from the remote storage devices intelligently based on reading patterns and/or pre-configured policies of the VMs and caching the pre-fetched data in one or more storage devices locally coupled to the NVMe controller;
retrieving and providing data from the locally coupled storage devices to a VM immediately instead of retrieving the data from the remote storage devices over the network during a read operation on the logical volumes by said VM if the data requested by the read operation has been pre-fetched and cached in the locally coupled storage devices;
retrieving and providing data from the remote storage devices over the network to the VMs only if the data requested by the read operation has not been pre-fetched and cached in the locally coupled storage devices.

27. The method of claim 26, further comprising:
keeping track of the read patterns of the VMs during previous read operations and analyzing the read patterns to predict which logical volumes/blocks are most likely to be requested next by the VMs.

28. The method of claim 26, further comprising:
pre-fetching the data from the remote storage devices over the network via an instruction in accordance with a storage network protocol.

29. A computer-implemented method to support local caching for remote storage devices via a NVMe controller during a write operation, comprising:
creating one or more logical volumes in one or more non-volatile memory express (NVMe) namespaces mapped to a plurality of remote storage devices accessible over a network via a NVMe virtual controller running on a physical NVMe controller;
presenting the NVMe namespaces of the logical volumes mapped to the remote storage devices to a corresponding virtual machine (VM) running on a host;
storing data to be written to the remote storage devices by the VM in one or more storage devices locally coupled to the NVMe controller first before transmitting and saving the data to the remote storage devices over the network during said write operation on the logical volumes by the VM;
providing an acknowledgement to the VM in real time indicating the write operation has been successfully performed;
retrieving data for the write operation from the storage devices locally coupled to the NVMe controller and transmitting the retrieved data over the network to be saved to the remote storage devices.

30. A computer-implemented method to support local caching for remote storage devices via a NVMe controller during a read operation, comprising:
creating one or more logical volumes in one or more non-volatile memory express (NVMe) namespaces mapped to a plurality of remote storage devices accessible over a network via a NVMe virtual controller running on a physical NVMe controller;
presenting the NVMe namespaces of the logical volumes mapped to the remote storage devices to a corresponding virtual machine (VM) running on a host;
pre-fetching data from the remote storage devices intelligently based on reading patterns and/or pre-configured policies of the VM and caching the pre-fetched data in one or more storage devices locally coupled to the NVMe controller;
retrieving and providing data from the locally coupled storage devices to the VM immediately instead of retrieving the data from the remote storage devices over the network during a read operation on the logical volumes by the VM if the data requested by the read operation has been pre-fetched and cached in the locally coupled storage devices;
retrieving and providing data from the remote storage devices over the network to the VM only if the data requested by the read operation has not been pre-fetched and cached in the locally coupled storage devices.

31. The method of claim 30, further comprising:
enabling the virtual NVMe controller to interact with and allow access from one and only one VM.

32. The method of claim 30, further comprising:
supporting identity-based authentication and access by each of the virtual NVMe controllers from its corresponding VM for its operations, wherein each identity permits a different set of API calls for different types of commands used to create, initialize and manage the virtual NVMe controller and/or provide access to the logical volumes for the VM.
